(19) United States
(12) Patent Application Publication
(10) Pub. No.: US 2003/0234171 A1
(43) Pub. Date: Dec. 25, 2003

(54) Cracking furnace antifoulant injection system

(76) Inventors: Steven A. Owen, Kingwood, TX (US); Ron E. Brown, Bartlesville, OK (US); Tin Tack Cheung, Kingwood, TX (US); Timothy O. Odi, Kingwood, TX (US); Darin B. Tiedtke, Kingwood, TX (US); Joseph Bergmeister III, Kingwood, TX (US)

Correspondence Address: Rodney B Carroll, Conley Rose P C, 5700 Granite Parkway, Suite 330, Plano, TX, 75024, US

(21) Appl. No.: 10/174,624

(22) Filed: Jun. 19, 2002

(51) Int. Cl. C10B 43/00; B01J 10/00; C10B 51/00

(52) U.S. Cl. 202/241; 201/2; 422/194

(57) ABSTRACT

An apparatus and a method for injecting an antifoulant has been developed for suppressing coke formation during pyrolysis in a cracking furnace. The apparatus and method result in the antifoulant being atomized and vaporized, which is critical for proper distribution of the antifoulant. The proper distribution of the antifoulant through this novel apparatus and method results in longer runtime and higher efficiencies for cracking furnaces.

### FIELD OF THE INVENTION

This invention is related to the field of processes for injecting an antifoulant into a cracking furnace to inhibit coke byproducts. This invention also relates to the field concerning an apparatus for injecting antifoulant into a cracking furnace for coke inhibition. Specifically, this invention provides a method and apparatus by which an antifoulant is atomized and vaporized to allow for proper injection into a cracking furnace.

### SUMMARY OF THE INVENTION

An object of this invention is to provide an apparatus to inject an antifoulant into a cracking furnace.

Another object of this invention is to provide an apparatus to atomize the antifoulant.

Another object of this invention is to provide an apparatus to vaporize the antifoulant.

Yet another object of this invention is to provide a method for injecting the antifoulant into the cracking furnace.

In accordance with one embodiment of this invention, an apparatus for injecting the antifoulant into a cracking furnace is provided, the apparatus comprises:

(1) an injection means to atomize the antifoulant;

(2) a vaporization means to vaporize the antifoulant received from the injection means; and

(3) a carrier means to move the antifoulant from the injection means through the vaporization means into the cracking furnace.

In accordance with another embodiment of this invention, an apparatus for injecting the antifoulant chemical into a cracking furnace is provided, the apparatus comprises:

(1) an injection means to atomize the antifoulant;

(2) a vaporization means to vaporize the antifoulant received from the injection means;

(3) a carrier means to move the antifoulant from the injection means through the vaporization means into the cracking furnace;

(4) a storage means to store the antifoulant;

(5) a pumping means to pump the antifoulant from the storage means; wherein the pumping means comprises a positive displacement pump;

(6) a filter means to filter particulates from the antifoulant; and

(7) a dampening means after the pumping means to provide stable flow of the antifoulant.

In accordance with another embodiment of this invention, an apparatus for injecting the antifoulant into a cracking furnace is provided, the apparatus comprises:

(1) an injection means to atomize the antifoulant wherein the injection means comprises a nozzle capable of atomizing the antifoulant to a particle size below about 30 microns;

(2) a vaporization means to vaporize the antifoulant received from the injection means;

(3) a carrier means to move the antifoulant from the injection means through the vaporization means into the cracking furnace;

(4) a storage means to store the antifoulant;

(5) a pumping means to pump the antifoulant from the storage means;

(6) a filter means to filter particulates from the antifoulant wherein the filter means comprises a filter with a mesh size of less than about 100 micron; and

(7) a dampening means after the pumping means to provide stable flow of the antifoulant.

In accordance with another embodiment of this invention, a method for injecting antifoulant into a cracking furnace is provided, the method comprises the steps of:

(1) injecting the antifoulant and an atomizing fluid through an injection zone into a vaporization zone to produce an atomized antifoulant having a particle size sufficient to disperse the antifoulant;

(2) vaporizing the atomized antifoulant by injecting a vaporization fluid in the vaporization zone to produce a vaporized antifoulant; and

(3) routing the vaporized antifoulant to the cracking furnace.

In accordance with another embodiment of this invention, a method for injecting antifoulant chemical into a cracking furnace is provided, the method comprises the steps of:

(1) injecting the antifoulant and an atomizing fluid through an injection zone into a vaporization zone to produce an atomized antifoulant having a particle size sufficient to disperse the antifoulant;

(2) vaporizing the atomized antifoulant by injecting a vaporization fluid in the vaporization zone to produce a vaporized antifoulant;

(3) routing the vaporized antifoulant to the cracking furnace;

(4) pumping the antifoulant in a pumping zone to the injection zone;

(5) storing the antifoulant in a storing zone to provide for delivery to the pumping zone;

(6) filtering the antifoulant in a filtering zone to remove particulates prior to injecting; and

(7) dampening the antifoulant in a dampening zone after the pumping zone to provide for steady antifoulant flow.

In accordance with another embodiment of this invention, a method for injecting antifoulant chemical into a cracking furnace, said method comprises the steps of:

(1) injecting the antifoulant and an atomizing fluid through an injection zone into a vaporization zone to produce an atomized antifoulant having a particle size sufficient to disperse the antifoulant;

(2) vaporizing the atomized antifoulant by injecting a vaporization fluid in the vaporization zone to produce a vaporized antifoulant wherein the vaporization fluid is steam at a pressure in a range of about 50 psig to 450 psig;

(3) routing the vaporized antifoulant to the cracking furnace;

(4) pumping the antifoulant in a pumping zone to the injection zone wherein the pumping is at a rate of below about 10 gallons per hour;

(5) storing the antifoulant in a storing zone to provide for delivery to the pumping zone;

(6) filtering the antifoulant in a filtering zone to remove particulates prior to injecting wherein the filtering zone comprises a filter having a mesh size below 100 microns; and

(7) dampening the antifoulant in a dampening zone after the pumping zone to provide for steady antifoulant flow;

These objects, and other objects, will become apparent to those with ordinary skill in the art after reading this disclosure.

### BACKGROUND OF THE INVENTION

A cracking furnace will typically crack ethane, propane, butane and heavier hydrocarbon feeds to produce ethylene and others products. Unfortunately, a byproduct of the reaction is the formation of coke, which is essentially carbon. After a period of time, coke will build up inside the cracking furnace coils, and the cracking furnace will need to be shut down for about a day to burn the coke material from the inside of the cracking furnace coils. This process is known as a decoke procedure. The cracking furnace is shut down for a period of time, and air is introduced into the cracking furnace coils. The decoke process results in a loss of energy and production or overall efficiency of the operating unit.

A unique and novel invention is disclosed to inject an antifoulant into the cracking furnace to greatly reduce the coke forming reaction. Without a proper injection scheme, the antifoulant will be rendered ineffective. The injection system comprises an injection means, a vaporization means, and a carrier means. The atomization and vaporization of the antifoulant is critical to the successful delivery of the antifoulant in the cracking furnace in order to prevent coke buildup in the cracking furnace coils.

### DETAILED DESCRIPTION OF THE INVENTION

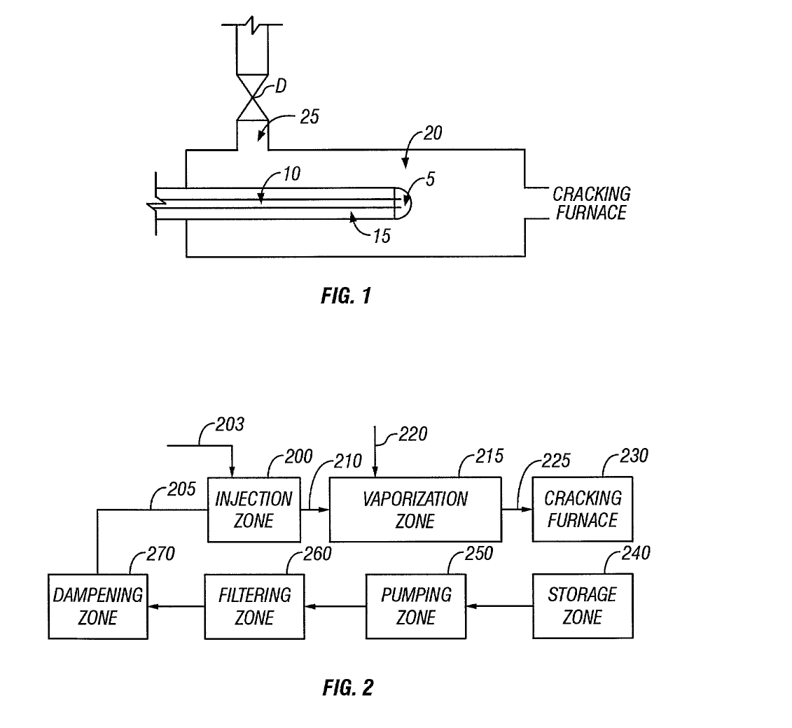

In the first embodiment of this invention, an apparatus for injecting antifoulant into a cracking furnace is provided as shown in FIG. 1. The apparatus comprises

(1) an injection means to atomize the antifoulant;

(2) a vaporization means to vaporize the antifoulant received from the injection means; and

(3) a carrier means to move the antifoulant from the injection means through the vaporization means into the cracking furnace.

The injection means atomizes the antifoulant 10. The injection means comprises:

(1) A mixing nozzle 5 to combine the antifoulant 10 with an atomization fluid 15

(2) an outer jacketing means containing the atomization fluid 15 which is connected to the mixing nozzle 5; and

(3) an inner jacketing means containing the antifoulant 10 connected to said mixing nozzle 5 whereby said antifoulant 10 is delivered to said mixing nozzle 5; wherein said inner jacketing means is inside said outer jacketing means.

The injection means comprises a mixing nozzle 5 used to combine the antifoulant 10 with an atomization fluid 15. The atomization fluid 15 can be any fluid known in the art to atomize the antifoulant to a particle size of less than about 30 microns. Preferably, the atomization fluid 15 is steam having a pressure in the range of about 80 psig to about 450 psig. More preferably, the steam pressure is in a range of about 110 psig to about 200 psig, and most preferably, the steam pressure is in the range of 120 psig to 180 psig. The antifoulant pressure is that which is sufficient to propel the antifoulant 10 in the mixing nozzle 5 and into the vaporization means 20. Generally, the pressure of the antifoulant 10 is about 25 psig higher than the pressure of the vaporization means. Preferably, the pressure of the antifoulant 10 is about 20 psig higher than the pressure of the vaporization means. Preferably the antifoulant is injected into a hydrocarbon gas or liquid charge line in a cracking furnace. Most preferably, the antifoulant is injected into a dilution steam line on the cracking furnace.

The vaporization means allows the antifoulant to vaporize. The vaporization mean comprises a chamber 20 of sufficient size to allow for vaporization of the antifoulant. The size of the chamber is that which is sufficient to adequately vaporize the antifoulant. Preferably, the diameter of the chamber 20 is in the range of about 4 to about 12 inches. Most preferably, the diameter of the chamber 20 is in the range of 6 to 10 inches. Preferably, the length of the chamber 20 is in the range of about 4 to 12 feet. Most preferably, the length of the chamber 20 is 6 to 12 feet.

The carrier means 25 comprises a carrier fluid capable of moving the antifoulant through the vaporization means. Preferably, the carrier means 25 is steam with a pressure in the range of about 110 psig to 250 psig. Most preferably, the steam has a pressure is in the range of 110 psig to 200 psig. The steam is used in a quantity of about 300 lbs/hr to about 1500 lbs/hr. Preferably, the steam is used in a quantity of about 500 lbs/hr to about 1000 lbs/hr. Most preferably, the steam is used in a quantity of 500 lbs/hr to 800 lbs/hr.

Optionally, the apparatus can include a storage means to store the antifoulant. The storage means can be any type of storage equipment known in the art. For example, the storage mean can be a tank or cylinder. Preferably, the storage means comprises a tank with a capacity of about 200 to about 1000 gallons. More preferably, the storage capacity is in the range of about 300 to about 600 gallons. Most preferably, the storage capacity is in the range of 400 to 500 gallons.

Optionally the apparatus can include a pumping means to pump the antifoulant from the storage means. The pumping means can be any pump known in the art. Preferably, the pumping means is a positive displacement pump or a centrifugal pump. Most preferably, the pumping means is a positive displacement pump.

Optionally the apparatus can include a dampening means comprising a dampening pot to stabilize the flow rate created by the pumping means. The dampening means is especially important when the pumping means is a positive displacement pump. The dampening means can comprise any pulsation dampener know in the art.

Optionally the apparatus can include a filter means to filter particulates from the anitfoulant. The filter means comprises any filter known in the art capable of removing particulates from the antifoulant. Typically, the filter means comprises a filter having a mesh size of less than about 100 microns. Preferably, the filter has mesh size of less than about 50 microns. Most preferably, the filter has a mesh size that is less than about 30 microns.

In another embodiment of this invention, a method for injecting antifoulant into a cracking furnace is provided as shown in FIG. 2.

Step (1) is injecting an antifoulant 205 and an atomizing fluid 203 through an injection zone 200 into a vaporization zone 215 to produce an atomized antifoulant 210 having a particle size sufficient to disperse the atomized antifoulant 210. The injection is accomplished by an injection nozzle and can be accomplish by any means known in the art. The injection zone 200 can be contained within the vaporization zone 215 or before the vaporization zone 215. Preferably, the injection zone 200 is contained within the vaporization zone 215. Typically, the particle size of the atomized antifoulant 210 is less than about 30 microns. Preferably, the particle size of the atomized antifoulant 210 is less than about 25 microns. Most preferably, the particle size of the atomized antifoulant 210 will be less than 20 microns.

Step (2) is vaporizing the atomized antifoulant 210 by injecting a vaporization fluid 220 in the vaporization zone 215 to produce a vaporized antifoulant 225. The vaporization fluid 220 can be any compound known in the art capable of vaporizing the atomized antifoulant 210. Preferably, the vaporization fluid is steam. The steam has a pressure that which is sufficient to vaporize the antifoulant and propel the antifoulant into the cracking furnace. Generally, the steam has a pressure in a range of about 80 psig to 450 psig. Preferably, the steam has a pressure in a range of about 110 psig to about 200 psig. Most preferably, the stream has a pressure in a range of 120 psig to 180 psig. The vaporized antifoulant 225 can be injected into either the dilution steam or the hydrocarbon feed to the cracking furnace 230. Preferably, the vaporized antifoulant 225 is injected in the dilution steam line of the cracking furnace 230

Optionally the antifoualnt can be pumped through a pumping zone 250 to the injection zone 200. The pumping zone 250 comprises any pump known in the art. Preferably, the pumping zone 250 comprises a positive displacement pump or a centrifugal pump. Most preferably, the pumping zone 250 comprises a positive displacement pump.

Optionally, the antifoulant can be stored in a storage zone 240 to provide for delivery to the pumping zone 250. The storage zone typically comprises at least one selected from the group consisting of tanks, d-cylinders, totes or any storage vessels known in the art. Typically, the storage zone comprises a tank with a capacity of about 200 to about 1000 gallons. Preferably, the tank has a capacity in a range of about 300 to about 600 gallons. Most preferably, the tank has a capacity in a range of 400 to 500 gallons.

Optionally the antifoulant can be filtered in a filtering zone 260 to remove particulates prior to injecting. The filtering zone 260 comprises any filter known in the art. Generally, the filter has a mesh size of less than 100 microns. Preferably, the filter mesh size is less than 50 microns. Most preferably, the filter has a mesh size that is less than 30 microns.

Optionally the antifoulant can be dampened in a dampening zone 270 after the pumping zone to provide for steady antifoulant flow. The dampening can be accomplished by any means know in the art. Typically, the dampening zone 270 comprises a pulsation dampener.

That which is claimed is:

1. An apparatus for injecting an antifoulant into a cracking furnace comprising:
(1) an injection means to atomize said antifoulant;
(2) a vaporization means to vaporize said antifoulant received from said injection means; and
(3) a carrier means to move said antifoulant from said injection means through said vaporization means into said cracking furnace.

2. An apparatus according to claim 1 further comprising a storage means to store said antifoulant.

3. An apparatus according to claim 1 further comprising a pumping means to pump said antifoulant from said storage means.

4. An apparatus according to claim 1 further comprising a filter means to filter particulates from said antifoulant.

5. An apparatus according to claim 3 further comprising a dampening means after said pumping means to provide stable flow of said antifoulant.

6. An apparatus according to claim 1 wherein said injection means comprises a nozzle capable of atomizing particle size of said antifoulant to a particle size below about 30 microns.

7. An apparatus according to claim 3 wherein said pumping means comprises a positive displacement pump.

8. An apparatus according to claim 3 wherein said pumping means comprises a centrifugal pump.

9. An apparatus according to claim 4 wherein said filter means comprises a filter with a mesh size of less than about 100 microns.

10. An apparatus according to claim 9 wherein said filter means comprises a filter with a mesh size of less than 50 microns.

11. An apparatus according to claim 1 wherein said injection means comprises:
(1) a mixing nozzle to combine said antifoulant with an atomization fluid;
(2) a outer jacketing means connected to said mixing nozzle whereby said atomization fluid is delivered to said mixing nozzle; and
(3) an inner jacketing means connected to said mixing nozzle whereby said antifoulant is delivered to said mixing nozzle; wherein said inner jacketing means is inside said outer jacketing means.

12. An apparatus for injecting an antifoulant into a cracking furnace comprising:
(1) an injection means to atomize said antifoulant;
(2) a vaporization means to vaporize said antifoulant received from said injection means;
(3) a carrier means to move said antifoulant from said injection means through said vaporization means into said cracking furnace;
(4) a storage means to store said antifoulant;
(5) a pumping means to pump said antifoulant from said storage means wherein said pumping means comprises a positive displacement pump;
(6) a filter means to filter particulates from said antifoulant; and
(7) a dampening means after said pumping means to provide stable flow of said antifoulant.

13. An apparatus for injecting an antifoulant into a cracking furnace comprising:
(1) an injection means to atomize said antifoulant wherein said injection means comprises a nozzle capable of atomizing particle size of said antifoulant to a particle size below about 30 microns;
(2) a vaporization means to vaporize said antifoulant received from said injection means;
(3) a carrier means to move said antifoulant from said injection means through said vaporization means into said cracking furnace;
(4) a storage means to store said antifoulant;
(5) a pumping means to pump said antifoulant from said storage means;
(6) a filter means to filter particulates from said antifoulant wherein said filter means comprises a filter with a mesh size of less than about 100 microns. ; and
(7) a dampening means after said pumping means to provide stable flow of said antifoulant.

14. A method for injecting an antifoulant into a cracking furnace said method comprising the steps of:
(1) injecting said antifoulant and an atomizing fluid through an injection zone into a vaporization zone to produce an atomized antifoulant having a particle size sufficient to disperse said antifoulant;
(2) vaporizing said atomized antifoulant by injecting a vaporization fluid in said vaporization zone to produce a vaporized antifoulant; and
(3) routing said vaporized antifoulant to said cracking furnace.

15. A method for injecting antifoulant according to claim 14 further comprising pumping said antifoulant in a pumping zone to said injection zone.

16. A method for injecting antifoulant according to claim 15 further comprising storing said antifoulant in a storing zone to provide for delivery to said pumping zone.

17. A method for injecting antifoulant according to claim 14 further comprising filtering said antifoulant in a filtering zone to remove particulates prior to injecting.

18. A method for injecting antifoulant according to claim 15 further comprising dampening said antifoulant in a dampening zone after said pumping zone to provide for steady antifoulant flow.

19. A method for injecting antifoulant according to claim 15 wherein said pumping is at a rate of below about 10 gallons per hour.

20. A method for injecting antifoulant according to claim 19 wherein said pumping is at a rate between about 1 gph to about 5 gph.

21. A method for injecting antifoulant according to claim 17 wherein said filtering zone comprises a filter having a mesh size below 100 microns.

22. A method for injecting antifoulant as according to claim 14 wherein said antifoulant is atomized to a particle size below 30 microns.

23. A method for injecting antifoulant according to 14 wherein said vaporization fluid is steam at a pressure in a range of about 50 psig to 450 psig.

24. A method for injecting antifoulant according to claim 23 wherein said vaporization fluid is steam at a pressure in a range of about 130 psig to 200 psig.

25. A method for injecting an antifoulant into a cracking furnace said method comprising the steps of:
(1) injecting said antifoulant and an atomizing fluid through an injection zone into a vaporization zone to produce an atomized antifoulant having a particle size sufficient to disperse said antifoulant;
(2) vaporizing said atomized antifoulant by injecting a vaporization fluid in said vaporization zone to produce a vaporized antifoulant; and
(3) routing said vaporized antifoulant to said cracking furnace;
(4) pumping said antifoulant in a pumping zone to said injection zone;
(5) storing said antifoulant in a storing zone to provide for delivery to said pumping zone;
(6) filtering said antifoulant in a filtering zone to remove particulates prior to injecting; and
(7) dampening said antifoulant in a dampening zone after said pumping zone to provide for steady antifoulant flow.

26. A method for injecting an antifoulant into a cracking furnace said method comprising the steps of:
(1) injecting said antifoulant and an atomizing fluid through an injection zone into a vaporization zone to produce an atomized antifoulant having a particle size sufficient to disperse said antifoulant;
(2) vaporizing said atomized antifoulant by injecting a vaporization fluid in said vaporization zone to produce a vaporized antifoulant wherein said vaporization fluid is steam at a pressure in a range of about 50 psig to 450 psig;
(3) routing said vaporized antifoulant to the dilution steam line of said cracking furnace;
(4) pumping said antifoulant in a pumping zone to said injection zone wherein said pumping is at a rate of below about 10 gallons per hour;
(5) storing said antifoulant in a storing zone to provide for delivery to said pumping zone;
(6) filtering said antifoulant in a filtering zone to remove particulates prior to injecting wherein said filtering zone comprises a filter having a mesh size below 100 microns; and
(7) dampening said antifoulant in a dampening zone after said pumping zone to provide for steady antifoulant flow.
